(19) United States
(12) Patent Application Publication
(10) Pub. No.: US 2011/0074798 A1
(43) Pub. Date: Mar. 31, 2011

(54) DISPLAY TERMINAL DEVICE, IMAGE DISPLAY CONTROL METHOD, AND STORAGE MEDIUM

(75) Inventor: Tomofumi NAKAYAMA, Tokoname-shi (JP)

(73) Assignee: BROTHER KOGYO KABUSHIKI KAISHA, Nagoya-shi (JP)

(21) Appl. No.: 12/890,261

(22) Filed: Sep. 24, 2010

(30) Foreign Application Priority Data
Sep. 29, 2009 (JP) 2009-224228

(51) Int. Cl. G06T 1/00

(52) U.S. Cl. 345/522

(57) ABSTRACT

A display terminal device is provided. The display terminal device includes a display unit, a display control unit configured to control the display unit to display a plurality of image information by switching the image information; an image information acquiring unit configured to acquire image information and display information which is associated with the image information and to be displayed while being added to the image information, a display information reproducing unit configured to reproduce and display the display information associated with the image information while the image information is being displayed, and a display switching control unit configured to control a switching time, at which one of the image information is switched to another of the image information while controlling the display information reproducing unit to reproduce and display the associated display information, based on the display information acquired by the image information acquiring unit.

### CROSS-REFERENCE TO RELATED APPLICATION

This application claims priority from Japanese Patent Application No. 2009-224228, filed on Sep. 29, 2009, the entire subject matter of which is incorporated herein by reference.

### TECHNICAL FIELD

Aspects of the present invention relate to a display terminal device which displays image information associated with display information, an image display control method, and a storage medium.

### BACKGROUND

It is know a digital photo frame which displays an image on a display unit by reading the image stored in a certain storage medium. Further, it is known a digital photo frame or a general display unit which can perform display control for a slideshow of displaying a plurality of images by intermittently switching the images in a certain time period. In addition, it is known a reproduction device which can perform display control for the slideshow by varying play speed and play time under preset conditions such that reproduction of the slideshow does not become monotonous or boring.

However, in the reproduction device, it is necessary to set the play speed or the play time in advance, and such setting operation is complicated. In addition, if a plurality of manual input information, such as a comment, are added to an image by a user using a device having a hand input unit, such as a touch panel, there is a desire to perform display control for displaying the image by a slideshow under conditions suitable for input conditions of the manual input information. However, currently, a technique for realizing this desire has not been provided.

### SUMMARY

Accordingly, it is an aspect of the present invention to provide a display terminal device which can switch a plurality of image information and display information, which is input information added to the image information, according to a switching time suitable for an input condition of the display information when reproducing and displaying the display information on the same display screen as of the image information, which is being displayed.

According to an illustrative embodiment of the present invention, there is provided a display terminal device comprising: a display unit including a display area for displaying image information; a display control unit configured to control the display unit to display a plurality of image information by switching the image information; an image information acquiring unit configured to acquire image information and acquire display information which is associated with the image information and is to be displayed while being added to the image information; a display information reproducing unit configured to reproduce and display the display information associated with the image information while the image information is being displayed on the display unit; and a display switching control unit configured to control a switching time, at which one of the image information displayed on the display unit is switched to another of the image information while controlling the display information reproducing unit to reproduce and display the associated display information, based on the display information associated with the image information acquired by the image information acquiring unit.

According to another illustrative embodiment of the present invention, there is provided a method for controlling a display terminal device including a display area for displaying image information and a display control unit configured to control the display unit to display a plurality of image information by switching the image information, the method comprising: acquiring image information and acquiring display information which is associated with the image information and is to be displayed while being added to the image information; reproducing and displaying the display information associated with the image information while the image information is being displayed; and based on the acquired display information associated with the image information, controlling a switching time, at which one of the image information displayed on the display unit is switched to another of the image information while reproducing and displaying the associated display information.

According to a further illustrative embodiment, there is provided a storage medium having a computer program stored thereon and readable by a computer for a display terminal device including a display area for displaying image information and a display control unit to control the display unit to display a plurality of image information by switching the image information, the computer program, when executed by the computer, causing the computer to perform operations comprising: acquiring image information and acquiring display information which is associated with the image information and is to be displayed while being added to the image information; reproducing and displaying the display information associated with the image information while the image information is being displayed; and based on the acquired display information associated with the image information, controlling a switching time, at which one of the image information displayed on the display unit is switched to another of the image information while reproducing and displaying the associated display information.

### BRIEF DESCRIPTION OF THE DRAWINGS

The above and other aspects of the present invention will become more apparent and more readily appreciated from the following description of illustrative embodiments of the present invention taken in conjunction with the attached drawings, in which:

FIG. 1 is a schematic configuration view of a display terminal device 10;

FIG. 2 is an electrical configuration view of the display terminal device 10;

FIG. 3 is an explanatory diagram of a flash ROM 24;

FIG. 4 is an explanatory diagram of an image information database 2411;

FIG. 5 is an explanatory diagram of a slideshow information database 2421;

FIG. 6 is an explanatory diagram of a display screen of the display terminal device 10;

FIG. 7 is an explanatory diagram of a display information database 2431;

FIG. 8 is a flowchart of a main process executed by the display terminal device 10;

FIG. 9 is a flowchart of a switching time-setting process executed by the display terminal device 10;

FIG. 10 is an explanatory view of a switching time information database 2422;

FIG. 11 is an explanatory diagram of a display screen of the display terminal device 10; and

FIG. 12 is an explanatory diagram of a display screen of the display terminal device 10 according to a modified illustrative embodiment.

### DETAILED DESCRIPTION

Hereinafter, a display terminal device according to an illustrative embodiment of the present invention will be described with reference to the accompanying drawings. However, it should be appreciated that these drawings are used merely to illustrate technical features that the present invention can adopt. The configuration of the apparatus, the flowchart of each process, and the like described herein are intended to be explanatory only, so that the present invention is not limited thereto.

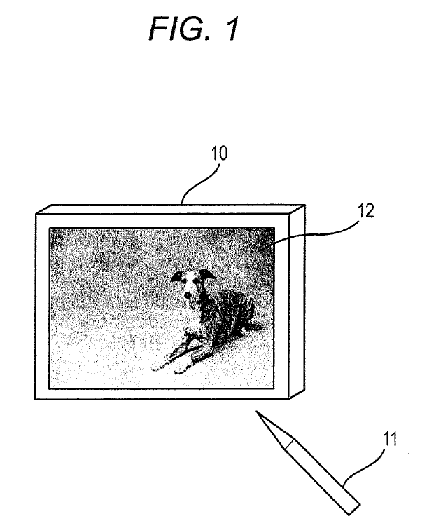

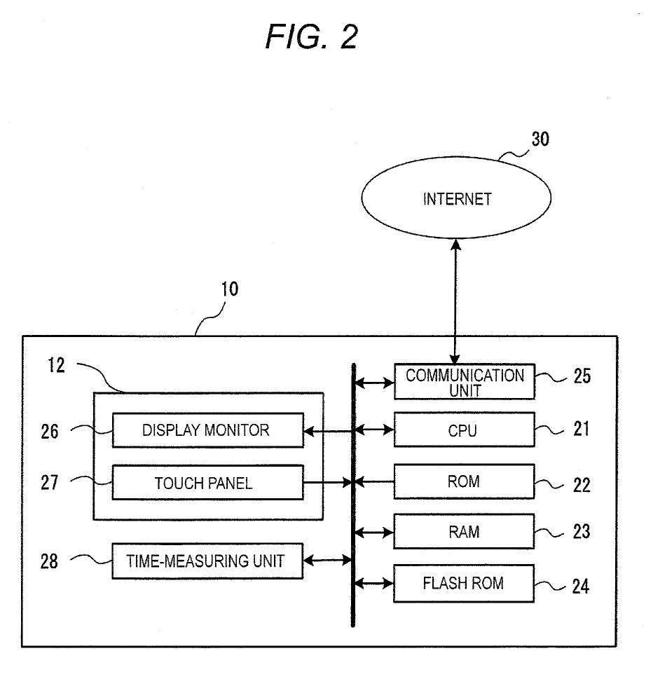

First, with reference to FIGS. 1 and 2, the outer configuration and electrical configuration of a display terminal device 10 according to an illustrative embodiment will be described.

With reference to FIG. 1, the display terminal device 10 of this illustrative embodiment will be described. As shown in FIG. 1, the display terminal device 10 includes a rectangular casing and a display unit 12 provided in the casing to display image information. A touch panel is provided to overlap the display unit 12, and acquires position information, which is input by a finger of a user or a touch pen 11 for the touch panel. The touch pen 11 is described by way of an example.

Next, with reference to FIG. 2, the electrical configuration of the display terminal device 10 will be described. As shown in FIG. 2, the display terminal device 10 of this illustrative embodiment includes a Central Processing Unit (CPU) 21, a Read Only Memory (ROM) 22, a Random Access Memory (RAM) 23, flash ROM 24, and a display monitor 26 and a touch panel 27, which configure the display unit 12, and also includes a time-measuring unit 28 and a communication unit 25. All of these components are connected to each other via bus.

The CPU 21 is configured to control the entire display terminal device 10. The ROM 22 stores a program or settings necessary for basic operations of the display terminal device 10. The CPU 21 controls the operations of the display terminal device 10 following the program stored in the ROM 22. The RAM 23 is a storage device that temporarily stores various data. The flash ROM 24 is a nonvolatile semiconductor memory that has various storage areas, which will be described later.

The display unit 12 includes an operation screen on which the user performs various operations on the display terminal device 10, a display monitor 26 that displays image data or the like acquired from other devices, and the general-use touch panel 27 that is provided to overlap the display monitor 26. When the user makes a touch input by referring to the display unit 12, the touch panel 27 can acquire position information on the touch input. The time-measuring unit 28 is a device that has a function of a watch to display the present time, and also has a function of adding present time information to the position information acquired by the touch panel. The communication unit 25 is a device that can transmit and receive image information to be displayed on the display unit 12, to and from other devices via the Internet 30. Herein, the communication unit 25 may be a device that can transmit and receive information via telephone lines.

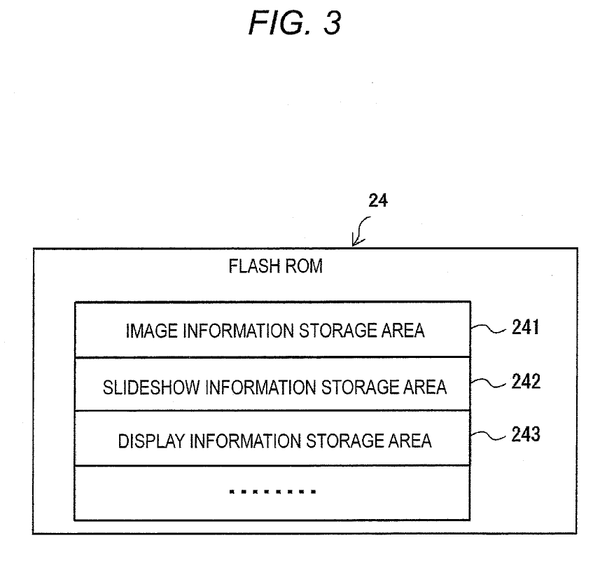

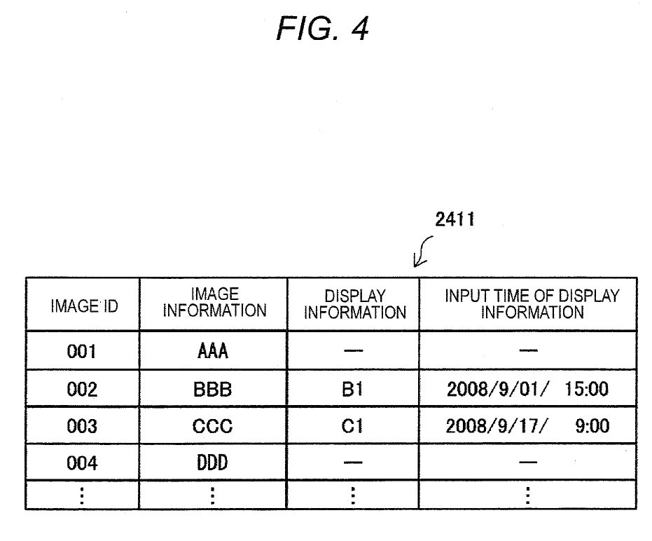

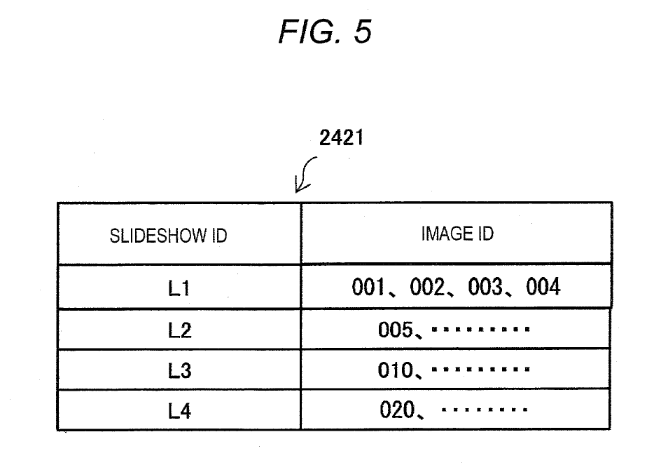

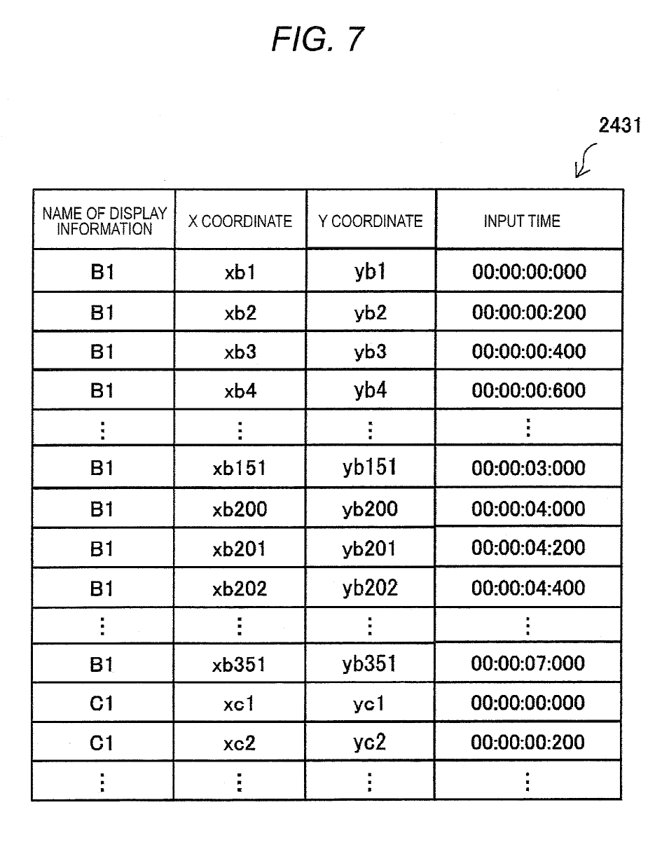

Next, with reference to FIGS. 3 to 5, the configuration of the flash ROM 24 will be described. The flash ROM 24 has a plurality of storage areas that includes an image information storage area 241, a slideshow information storage area 242, a display information storage area 243, and the like. The image information storage area stores an image information database 2411 as shown in FIG. 4, which includes image information on pictures or the like acquired from other devices. The slideshow information storage area 242 stores a slideshow information database 2421 as shown in FIG. 5, which includes information on a slideshow of displaying a plurality of image information by intermittently switching them at certain time intervals. The display information storage area 243 stores display information databases 2431 as shown in FIG. 7.

Herein, with reference to FIG. 4, the image information database 2411 will be described. In the image information database 2411, the items of image ID, image information, display information, and input time of display information are stored while being associated with one another. In the item of image ID, information for identifying image information is stored in the form of numerical information. The image ID is set to be automatically numbered when the display terminal device 10 acquires the image information. In the item of image information, the file name of the image information is stored. The image information is stored, such that information, for example, on file formats, such as Joint Photographic Experts Group (JPEG), Portable Network Graphics (PNG), and Graphics Interchange Format (GIF), corresponds to each file name. In the item of display information, identification information on information which the user has input by operating the display terminal device is stored in the form of symbols. A detailed description of display information will be given later. In the item of input time of display information, information on a time when the display information was started to be input by the user is stored.

Specifically, for example, in 002 of the image ID, image information corresponding to file name BBB, display information B1, and the input time of display information 2008/09/01/15:00 are stored while being associated with one another. The image ID 003 is similar to the image ID 002. However, as for image ID 001 and 004, image information is stored to be associated with AAA and DDD, but any display information and information on input time of the image information are not stored.

Next, with reference to FIG. 5, the slideshow information database 2421 will be described. In the slideshow information database 2421, the item of slideshow ID and image ID are stored while being associated with each other. In the slideshow ID, identification information for identifying information on a slideshow is stored in the form of symbols. The slideshow ID is set to be automatically numbered when a user makes out the slideshow by selecting a plurality of image information. In the item of image ID, an image ID of image information is stored as information to be displayed as the slideshow, selected from a plurality of image information stored in the image information database 2411. For example, when the slideshow ID is L1, image ID 001, 002, 003, 004 is stored while being associated with L1. Therefore, when the user selects L1 of the slideshow ID by operating the display terminal device 10, image information and display information associated with 001, 002, 003, and 004 of the image ID can be displayed on the display unit 12 by a slideshow.

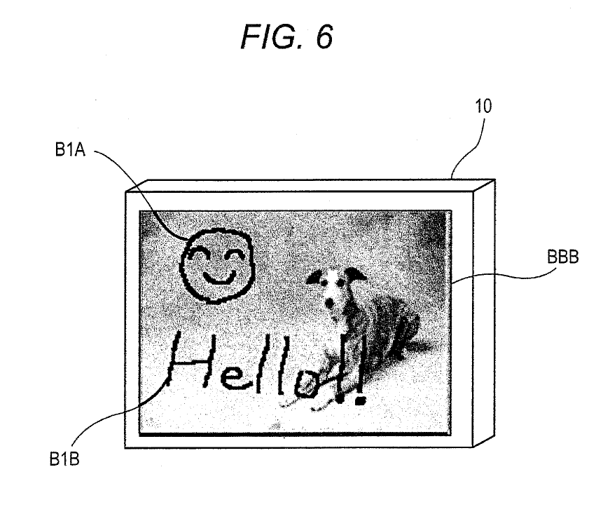

With reference to FIGS. 6 and 7, display information associated in the image information database 2411 will be described in detail. FIG. 6 is an explanatory diagram of a display screen of the display unit 12 of the display terminal device 10, in which image information corresponding to file name BBB of image ID 002 of the image information database 2411 and display information B1 (B1A, B1B) corresponding thereto are displayed at the same time. As shown in FIG. 6, both display information B1 (B1A, B1B) are information that the user has input for the image information as a symbol, a picture or characters, such as a comment, by the user's hand using the touch panel. As shown in FIG. 7, the display information B1 (B1A, B1B) is stored in the display information storage area 243 as the display information database 2431 including coordinate information for display on the display unit 12.

Here, with reference to FIG. 7, the display information databases 2431 will be described in detail. In the display information database 2431, an item of display information name, X coordinate, Y coordinate, and input time are stored while being associated with one another. In the item of display information name, information name for identifying display information is stored. In the items of X coordinate and Y coordinate, information representing a relative display position of display information input to the touch panel 27 is stored in the form of numerical values at every certain time interval (e.g., 200 ms interval), using a certain reference position in a display area of corresponding image information, for example, the center position or the position of an upper left corner as reference coordinates (0, 0). In the item of input time, input time is stored in the form of year/month/day/hour:minute:second:ms, corresponding to X and Y coordinate information, from an input start time and measured by the time-measuring unit 28 of the display terminal device 10. For example, as shown in FIG. 7, display information B1, input by the user, indicates that the time of a touch input in a position, having an X coordinate of xb1 and a Y coordinate of yb1, is started to be input at 00:00:00:000. Further, it is indicated that a touch input is made in a position, having an X coordinate of xb2 and a Y coordinate of yb2, at a time 00:00:00:200 after a certain time interval of 200 ms. Subsequently, at every time interval of 200 ms, coordinate information, which the user has input on the touch panel by the hand, is stored in the display information database 2431. Further, the display information database 2431 shown in FIG. 7 indicates, in this illustrative embodiment, that B1A of display information B1 is stored as information that has X coordinates from xb1 to xb151 and Y coordinates from yb1 to yb151. After B1A as described above, display information B1B is stored as information that has X coordinates from xb200 to xb351 and Y coordinates from yb200 to yb351. In the display information database 2431, an input time, during which display information B1 has been input by the user, can be calculated to be 7 seconds because an input complete time is 00:00:07:000 after input is started.

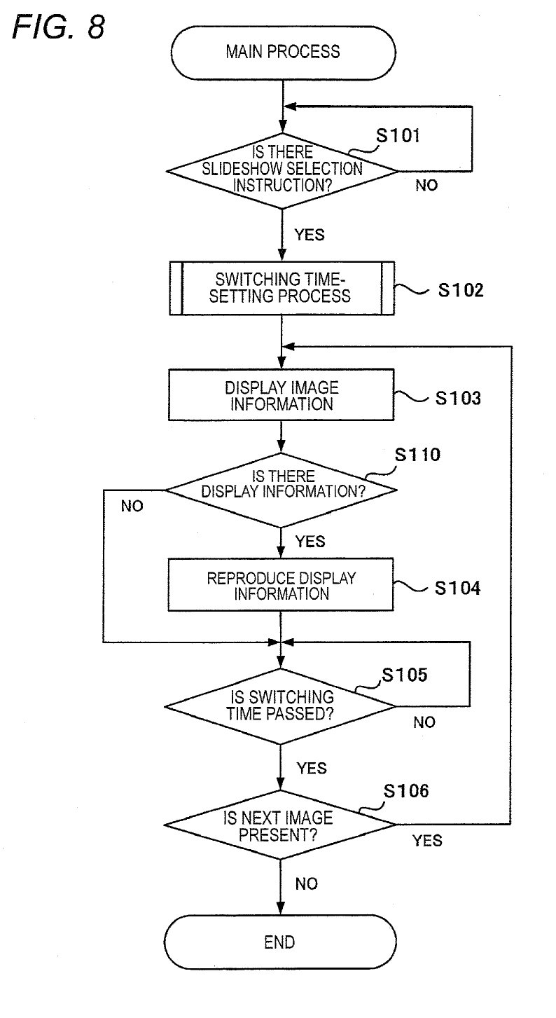

With reference to FIG. 8, a description will be given of a main process executed by the display terminal device 10. The main process shown in FIG. 8 is a process that the CPU 21 executes following the program stored in the ROM 22.

The main process shown in FIG. 8 starts when the power of the display terminal device 10 is turned on. First, the CPU 21 determines whether or not there is a slideshow selection instruction (S101). Here, it is determined whether or not the user has instructed and input an ID of a slideshow, which the user intends to reproduce, from the slideshow database by operating the display terminal device 10. A detailed description of an instruction input method herein is omitted. However, for example, an input method including displaying a selection screen of slideshow IDs on the display unit 12, so that the user inputs an instruction using the touch pen 11 or a finger, or a method of allowing the user to directly input the number of the slideshow ID can be used.

In the process of step S101, if the CPU 21 determines that there is no slideshow selection instruction (S101: NO), the process returns to step S101 and continues to repeat. In the process of step S101, if the CPU 21 determines that there is a selection instruction of a slideshow (S101: YES), a switching time-setting process is executed (S102).

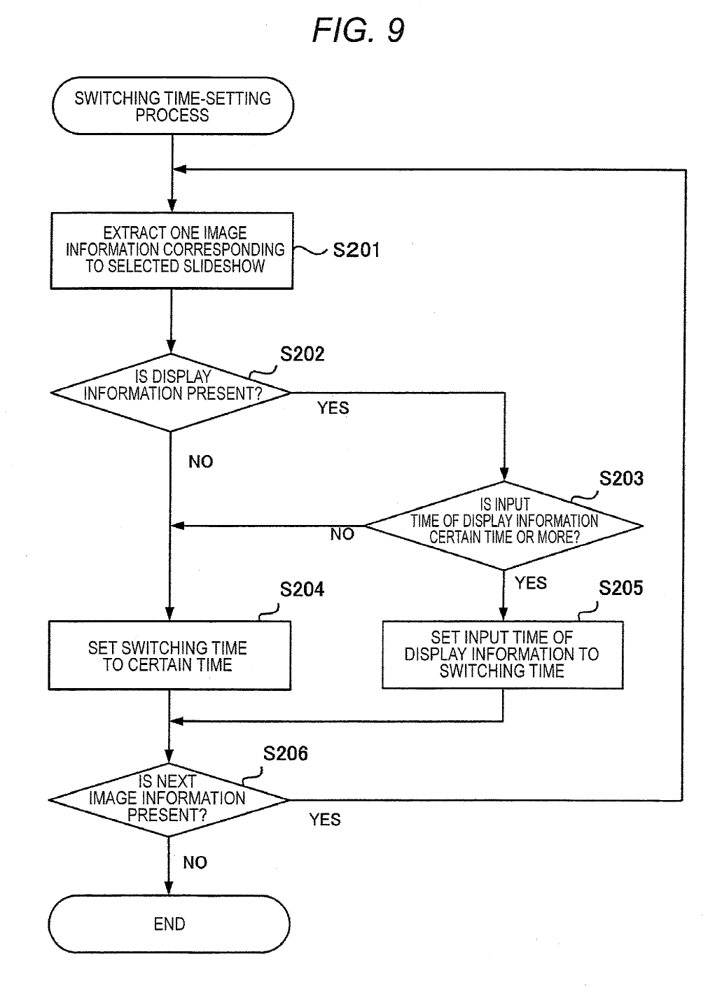

Here, with reference to FIG. 9, the switching time-setting process will be described. FIG. 9 is a flowchart of a switching time-setting process. First, the CPU 21 executes the process of extracting image information, which is associated with the selected slideshow (S201). In detail, in this process, the ID of the slideshow selected in the process of step S101 in FIG. 8 is specified in the slideshow information database 2421, and the image information on the image ID stored in the item of corresponding image ID is extracted from the image information database 2411. For example, in this illustrative embodiment, in the process of step S101, if L1 is selected as slideshow ID by the user, 001, 002, 003, and 004 of image IDs are specified with reference to the slideshow information database 2421, and furthermore, a plurality of information corresponding to image IDs, such as 001, 002, 003, and 004, are extracted with reference to the image information database 2411.

Next, the CPU 21 executes a process of determining whether or not display information corresponding to the image ID extracted in step S201 is stored with reference to the image information database 2411 (S202). If it is determined that there is no corresponding display information as the result of the process of S202 (S202: NO), the CPU 21 executes a process of setting a switching time to a certain time (S204), and executes a process of determining whether or not there is next image information to be extracted (S206).

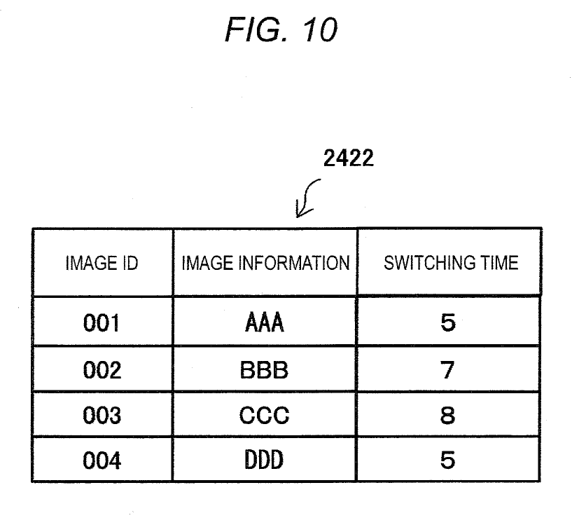

Here, the process of above steps S201, S202, S204, and S206 will be described in detail. In the process of step S201, image ID 001 is extracted first, the CPU 21 determines that display information corresponding to image ID 001 is not stored with reference to the image information database 2411 (S202: NO). Then, in the process of step S204, the switching time is set to a certain time (for example 5 seconds in this illustrative embodiment), and a switching time information database 2422 shown in FIG. 10 is temporarily configured and stored in the RAM 23. In the switching time information database 2422 shown in FIG. 10, items of image ID, image information, and switching time are stored while being associated with one another. Herein, the switching time indicates a time until one image information displayed on the display unit 12 of this illustrative embodiment is switched into another image information. Therefore, in the case of image ID 001, the switching time is stored to be 5 seconds. After the process of step S204, in the process of step S206, it is determined that image ID 002 after image ID 001 is stored (S206 YES), and the process returns to step S201.

Returning to the explanation of the process of step S202 (FIG. 9), if it is determined that the image information extracted in step S201 has display information (S202: YES), it is determined whether or not the input time of the display information is a certain time period or more (5 seconds in this illustrative embodiment) (S203). In addition, in the process of step S203, if the CPU 21 determines that the input time is a certain time period or more (S203: YES), it executes a process of setting a determined input time as a switching time (S205), and determines whether or not there is next image information to be extracted (S206). If it is determined that the input time is not a certain time period or more (S203: NO), step S204 similarly to the above is executed, and then, the process of step S206 is executed.

Here, the processes of steps S202 to S206 will be described in detail with respect to this illustrative embodiment. If image ID 002 after image ID 001 is extracted in the process of step S201, the process of step S202 determines that there is display information B1 corresponding to image ID 002 by referring to the image information database 2411 (FIG. 4) (S202: YES). Then, the process of step S203 calculates the input time of display information B1 to be 7 seconds as described above from input time information of the display information database 2431 that is stored while being associated with B1, and thereby determines that the certain time of this illustrative embodiment is 5 seconds or more (S203: YES). Thus, the input time of 7 seconds is stored in the switching time information database 2422 as the switching time of image ID 002 (S203). Therefore, the switching time of image information corresponding to file name BBB of image ID 002 is set to be 7 seconds during which display information has been input by the user.

In the process of step S203, although a detailed example corresponding to this illustrative embodiment is omitted, if it is determined that the input time of input information is less than the certain time of 5 seconds (S203: NO), the switching time is set to be the certain time of 5 seconds in order to prevent the switching time of image information from being excessively short (S204).

After the process of step S204 or step S205, it is determined whether or not there is image ID after the image ID extracted in step S201 (S206). In a case of the slideshow ID of L1 in this illustrative embodiment, after image IDs 001 to 004 are sequentially extracted, it is determined that there is no next image information (S206: NO), and the switching time setting process as the main process is completed.

Returning to the main process in FIG. 8, after the switching time-setting process of step S102 is executed, the CPU 21 executes a process of displaying image information (S103). In the process of step S103, the CPU 21 performs the process of extracting image ID corresponding to the slideshow ID, to which the selection instruction was made in the process of step S101, with reference to the slideshow information database 2421, and displaying the extracted image ID on the display unit 12. Specifically, since L1 has been selected as the slideshow ID in step S101, initial image ID 001 corresponding to L1 of the slideshow ID is specified, and image information AAA is displayed on the display unit 12 with reference to the image information database 2411 (S103).

After step S103, it is determined whether or not there is display information corresponding to the image information that is being displayed (S110). Specifically, in the process of step S110, with reference to image information database 2411, it is determined whether or not there is display information corresponding to the image information displayed in the process of step S103. In this illustrative embodiment, in the case of image ID 001, since display information corresponding to image ID 001 is not stored in the image information database 2411, it is determined that there is no display information in the process of step S110 (S110: NO), and the process proceeds to step S105. In the process of step S110, if it is determined that there is display information (S110: YES), the process of reproducing and displaying display information is executed (S104). Then, the CPU 21 then determines whether or not the switching time is passed (S105).

Describing step S105 in detail, after the display of image ID 001 is started in the process of step S103, the timer of the time-measuring unit 28 is started, a switching time of 5 seconds corresponding to image ID 001 is acquired from the switching time information database 2422, and it is determined whether or not 5 seconds are passed in the timer (S105). If the CPU 21 determines that the switching time is not passed, the process is repeated until the switching time is passed (S105: NO). In the process of step S105, if the CPU 21 determines that the switching time of image ID 001 is passed (S105: YES), it determines whether or not there is next image information to be displayed on the display unit 12. If the CPU 21 determines that there is next image information to be displayed (S106: YES), it returns to the process of step S103, switches the display to next image information to be displayed, and executes the following process of S110 and S104 to S106 in the same manner. Otherwise, if the CPU 21 determines that there is no next image information to be displayed in the process of step S106 (S106: NO), the main process is completed.

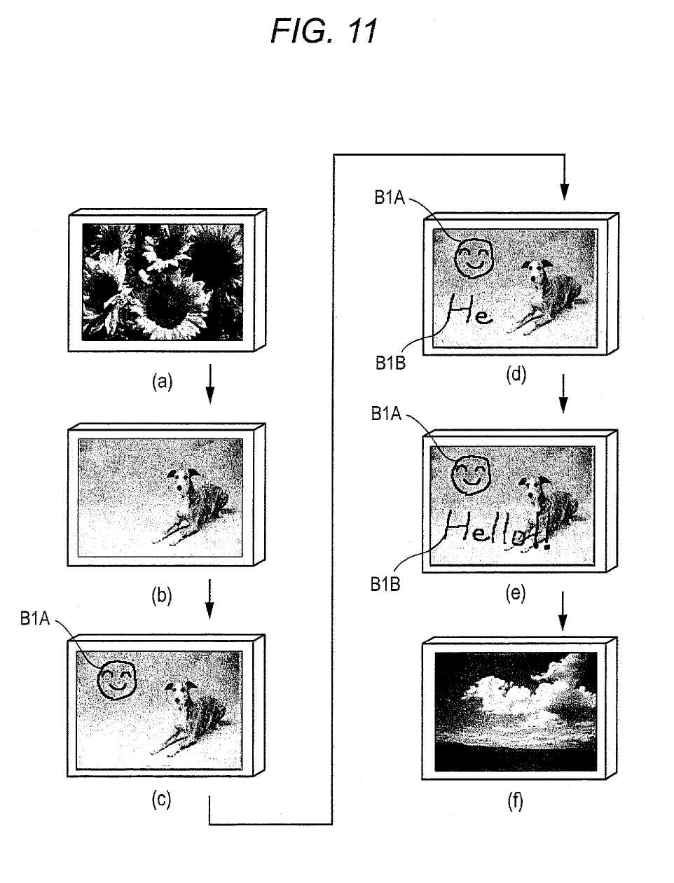

Here, the process of steps S103 to 5106 will be described further in detail with reference to explanatory diagrams of the display screen in FIG. 11. The display screen state in (a) of FIG. 11 indicates a state, in the process of step S103, image information corresponding to file name AAA of image ID 001 is displayed. In this state, display information corresponding to image ID 001 is not stored in the image information database 2411, it is determined that there is no display information in the process of step S110 (S110: NO), and therefore, no display information is displayed. In the process of step S105, the switching time of 5 seconds corresponding to image information corresponding to file name AAA is acquired from the switching time information database 2422, and the display is performed up to the switching time of 5 seconds after display of the image information corresponding to file name AAA is started. In the process of step S106, it is determined whether or not there is image information to be displayed after image ID 001 of image information corresponding to initially-displayed file name AAA. With reference to the slideshow information database 2421, it is determined that image ID 002 is stored (S106: YES).

Then, returning to the process of step S103, the process of switching the display to image information associated with the file name corresponding to next image ID 002 to be display is executed (S103, and the process is switched to the display screen as shown in (b) of FIG. 11. Next, in the process of step S110, with reference to the image information database 2411, since display information B1 corresponding to image information corresponding to file name BBB, which is being displayed, is stored, it is determined that there is display information (S110: YES). Based on corresponding coordinate information on the display information database 2431, as shown in (b) of FIG. 11, the process of reproducing and displaying B1A, i.e., part of display information B1 is executed so that the display information B1A overlaps image information corresponding to file name BBB, which is being displayed. (c) of FIG. 11 indicates the sate after display information B1A is reproduced and displayed. It is noted that reproduction display described herein indicates a process of adding displays in the sequence, by which image information is input, to display positions corresponding to coordinate information stored in the display information database 2411 at certain time intervals (i.e., 200 ms intervals in this illustrative embodiment). Therefore, while image information corresponding to file name BBB is being displayed, the user can observe the way how display information B1A is input for 3 seconds by the above-described reproduction display. Thereafter, with reference to information on input time of the display information database 2431, the CPU 21 starts reproducing and displaying display information B1B at 1 second after the reproduction display of display information B1A and performs reproduction display for 3 seconds. Therefore, as shown on the display screen in (d) and (e) of FIG. 11, display information B1 (B1A, B1B) is reproduced and displayed as display information to overlap the display of image information corresponding to file name BBB.

Further, in the process of step S105, 7 seconds, i.e., the switching time corresponding to image ID 002, which is being display, is acquired with reference to the switching time information database 2422. Thus, the reproduction display of display information B1 is executed until 7 seconds after image information corresponding to file name BBB is started to be display. If it is determined that 7 seconds is passed in the process of step S105 (S105: YES), the process returns step S106 specifies image information corresponding to file name CCC of image ID 003, which is next image information to be display. As shown in (f) of FIG. 11, the process of switching the display to image information corresponding to file name CCC is executed. Although explanatory diagrams of the display screen after (f) of FIG. 11 are omitted, similarly to the above-described process after step S103, display information C1, which is stored and associated with image information corresponding to file name CCC, is reproduced and displayed. The display is performed for 8 seconds, i.e., the switching time, and the process of switching the display to image information corresponding to file name DDD of next image ID 004 to be displayed is performed. After image information corresponding to file name DDD has been displayed for 5 seconds, in the process of step S106, it is determined that next image ID to be displayed is not stored in L1 of slideshow ID that is stored in the slideshow information database 2421 (S106: NO). Accordingly, the main process is completed.

Therefore, due to the main process of this illustrative embodiment executed as above, while image information is being displayed on the display unit, the user can observe a plurality of image information and a plurality of display information under suitable conditions by switching the display while reproducing and displaying display information, i.e., input information stored and associated with image information as if reproducing the input state thereof.

Meanwhile, the configuration and the process described in the above-described illustrative embodiment are explanatory and various alterations can be made. For example, although step S101 in the main process shown in FIG. 8 is set to specify image information to be display by selecting slideshow ID. However, the present invention is not limited thereto. For example, the process of step S101 can be omitted, and the process of step S102 may set to be performed on all of image information stored in the image information database 2411. Further, although step S106 is set to complete the main process if it is determined that there is no next image information to be displayed (S106: NO), the present invention is not limited thereto. For example, even if it is determined, in the process of step S106, that there is no next image, it is possible to return to initial image information and the process after step S103 can be repeatedly executed several times.

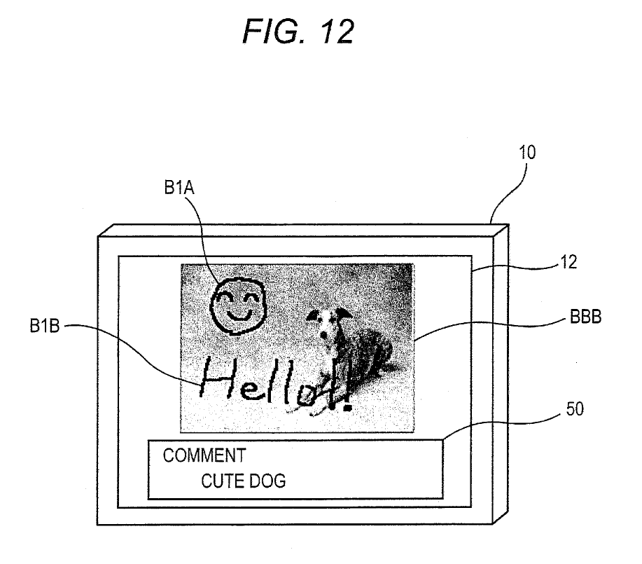

Further, in the above-described illustrative embodiment, the display information is information that the user has input for image information by the user's hand using the touch panel. However, the present invention is not limited thereto. The display information may be text data including information on characters input using a keyboard (not shown) or the like which can be connected to the display terminal device 10. As shown in FIG. 12, the text data may be displayed at a predetermined display area 50 provided at a lower portion of the display unit 12, for example. In this case, characters may be displayed as the display information in a same manner as when the characters were input or may be displayed one by one in order by a certain time such as 1 second for one character.

Further, in the above-described illustrative embodiment, the image information to be displayed on the display unit 12 is a still image. However, the present invention is not limited thereto. For example, the image information may be a moving image.

What is claimed is:

1. A display terminal device comprising:
a display unit including a display area for displaying image information;
a display control unit configured to control the display unit to display a plurality of image information by switching the image information;
an image information acquiring unit configured to acquire image information and acquire display information which is associated with the image information and is to be displayed while being added to the image information;
a display information reproducing unit configured to reproduce and display the display information associated with the image information while the image information is being displayed on the display unit; and
a display switching control unit configured to control a switching time, at which one of the image information displayed on the display unit is switched to another of the image information while controlling the display information reproducing unit to reproduce and display the associated display information, based on the display information associated with the image information acquired by the image information acquiring unit.

2. The display terminal device according to claim 1,
wherein the display information includes input information which is input by a user and time information indicating a time when the input information is input, while being associated with each other, and
wherein the display switching control unit is configured to set, as an input process time, a time interval from a time when input of the input information is started to a time when the input is completed, and is configured to set the input process time as the switching time.

3. The display terminal device according to claim 2, further comprising:
a determining unit configured to determine whether the input process time is a predetermined time or more,
wherein the display switching control unit is configured to set the input process time as the switching time if the determining unit determines that the input process time is the predetermined time or more.

4. The display terminal device according to claim 3,
wherein the display switching control unit is configured to set a certain time as the switching time if the determining unit determines that the input process time is less than the predetermined time.

5. The display terminal device according to claim 2,
wherein the image information acquiring unit is configured to acquire the image information associated with information which is manually input by a user as the display information.

6. The display terminal device according to claim 5,
wherein the display information is manually input by using a touch panel.

7. The display terminal device according to claim 2,
wherein the display information reproducing unit is configured to reproduce and display the display information in order of the input of the display information, based on the time information when the display information is input.

8. A method for controlling a display terminal device including a display area for displaying image information and a display control unit configured to control the display unit to display a plurality of image information by switching the image information, the method comprising:
acquiring image information and acquiring display information which is associated with the image information and is to be displayed while being added to the image information;
reproducing and displaying the display information associated with the image information while the image information is being displayed; and
based on the acquired display information associated with the image information, controlling a switching time, at which one of the image information displayed on the display unit is switched to another of the image information while reproducing and displaying the associated display information.

9. A storage medium having a computer program stored thereon and readable by a computer for a display terminal device including a display area for displaying image information and a display control unit to control the display unit to display a plurality of image information by switching the image information, the computer program, when executed by the computer, causing the computer to perform operations comprising:
acquiring image information and acquiring display information which is associated with the image information and is to be displayed while being added to the image information;
reproducing and displaying the display information associated with the image information while the image information is being displayed; and
based on the acquired display information associated with the image information, controlling a switching time, at which one of the image information displayed on the display unit is switched to another of the image information while reproducing and displaying the associated display information.
